(19) United States
(12) Patent Application Publication
(10) Pub. No.: US 2021/0358358 A1
(43) Pub. Date: Nov. 18, 2021

(54) TIMING CONTROLLER, DISPLAY DEVICE, APPARATUS AND METHOD FOR CONTROLLING REFRESH RATE

(71) Applicants: HEFEI BOE OPTOELECTRONICS TECHNOLOGY CO., LTD., Anhui (CN); BOE TECHNOLOGY GROUP CO., LTD., Beijing (CN)

(72) Inventor: Tao MA, Beijing (CN)

(21) Appl. No.: 16/336,539

(22) PCT Filed: Sep. 13, 2018
(86) PCT No.: PCT/CN2018/105420

§ 371 Date: Mar. 26, 2019

(30) Foreign Application Priority Data
Nov. 13, 2017 (CN) 201711113560.8

(51) Int. Cl. G09G 3/20; G09G 5/39

(52) U.S. Cl. CPC G09G 3/20; G09G 5/39; G09G 2360/16; G09G 2360/12; G09G 2310/08

(57) ABSTRACT

A timing controller, a display device, an apparatus and a method for controlling a refresh rate are disclosed. The method can include, receiving a frame of image data from a processor; determining whether the frame of image data passes a dynamic image verification; and in response to determining that the frame of image data passes the dynamic image verification, outputting the frame of image data so as to refresh a display image of the display panel once, or in response to determining that the frame of image data does not pass the dynamic image verification, skipping outputting of the image data so as to skip refreshing of the display image of the display panel once.

### CROSS-REFERENCE TO RELATED APPLICATION(S)

The present application is the U.S. national phase entry of PCT/CN2018/105420, with an international filing date of Sep. 13, 2018, which claims the priority of the Chinese patent application No. 201711113560.8, filed on Nov. 13, 2017, which is entirely incorporated herein by reference.

### TECHNICAL FIELD

The present disclosure relates to the display field, particularly to a timing controller, a display device, an apparatus and a method for controlling a refresh rate.

### BACKGROUND

Panel Self Refresh (PSR) is a characteristic of Embedded DisplayPort (eDP) standard issued by Video Electronic Standard Associate (VESA). It can drastically reduce the power consumption of a component such as a processor in displaying a static image, thus remarkably increasing the usable time of the battery in the portable environment. On the basis of this, Panel Self Refresh-2 (PSR2) technology with a characteristic of regional refresh further extends the scene of saving power consumption into the display scene having only the local image change, thus further reducing the power consumption of the system.

### SUMMARY

In an aspect in accordance with the present disclosure, there is provided a method for controlling a refresh rate of a display panel. In an exemplary embodiment, the method can comprise, receiving a frame of image data from a processor; determining whether the frame of image data passes a dynamic image verification; and in response to determining that the frame of image data passes the dynamic image verification, outputting the frame of image data so as to refresh a display image of the display panel once; or in response to determining that the frame of image data does not pass the dynamic image verification, skipping outputting of the image data so as to skip refreshing of the display image of the display panel once.

In an exemplary embodiment, the method can further comprise starting a timer matching with a first predetermined time length while outputting the frame of image data; determining that whether image data is output within the first predetermined time length since the frame of image data was output; and in response to determining that no image data is output within the first predetermined time length since the frame of image data was output, outputting a current frame of image data received from the processor in real time.

In an exemplary embodiment, a reciprocal of the first determined time length in seconds can be less than a frame rate in which the processor transmits image data frame by frame.

In an exemplary embodiment, the method can further comprise overwriting a frame of image data on a first buffering region when receiving the frame of image data from the processor. The determining whether the frame of image data passes a dynamic image verification can comprise, comparing the image data in the first buffering region and image data in a second buffering region, wherein the image data in the second buffering region is a most-recently output frame of image data; and determining whether a comparing result between the image data in the first buffering region and the image data in the second buffering region meets a predetermined difference condition.

In an exemplary embodiment, in response to determining that the frame of image data passes the dynamic image verification, outputting the frame of image data so as to refresh the display image of the display panel once can comprise, in response to determining that the comparing result between the image data in the first buffering region and the image data in the second buffering region meets the predetermined difference condition, outputting the image data in the first buffering region so as to refresh the display image of the display panel once and overwriting the image data in the first buffering region on the second buffering region.

In an exemplary embodiment, in response to determining that the frame of image data does not pass the dynamic image verification, skipping outputting of the frame of image data so as to skip refreshing of the display image of the display panel once can comprise, in response to determining that the comparing result between the image data in the first buffering region and the image data in the second buffering region does not meet the predetermined difference condition, skipping outputting of the image data in the first buffering region and waiting to receive a next frame of image data from the processor.

In an exemplary embodiment, the predetermined difference condition can comprise any one or more of the following: a quantity of pixels which have changing brightness values between the image data in the first buffering region and the image data in the second buffering region is larger than a first parameter; there is a pixel region in which the sum of changes of brightness values between the image data in the first buffering region and the image data in the second buffering region is larger than a second parameter; and there are changing regions between the image data in the first buffering region and the image data in the second buffering region between which a center interval is larger than a third parameter.

In an exemplary embodiment, the determining whether the frame of image data passes a dynamic image verification can comprise comparing the frame of image data with at least two frames of image data so as to determine whether the frame of image data passes the dynamic image verification.

In another aspect in accordance with the present disclosure, there is provided an apparatus for controlling a refresh rate of a display panel. In an exemplary embodiment, the apparatus can comprise a receiver configured to receive a frame of image data from a processor; a determining device configured to determine whether the frame of image data passes a dynamic image verification; an outputting device configured to, in response to determining that the frame of image data passes the dynamic image verification, output the frame of image data so as to refresh a display image of the display panel once; and a frame skipping device configured to, in response to determining that the frame of image data does not pass the dynamic image verification, skip outputting of the image data so as to skip refreshing of the display image of the display panel once.

In an exemplary embodiment, the apparatus can further comprise a timer configured to be started while outputting the frame of image data and to be matched with a first predetermined time length. The determining device can be configured to determine whether image data is output within the first predetermined time length since the frame of image data was output. The outputting device can be configured to, in response to determining that no image data is output within the first predetermined time length since the frame of image data was output, output a current frame of image data received from the processor in real time.

In an exemplary embodiment, a reciprocal of the first predetermined time length in seconds is less than a frame rate in which the processor transmits image data frame by frame.

In an exemplary embodiment, the apparatus can further comprise a first buffering region and a second buffering region. The first buffering region can be configured to overwrite a frame of image data when receiving the frame of image data from the processor. The second buffering region can be configured to save a most-recently output frame of image data. The determining device can be configured to, compare the image data in the first buffering region and the image data in the second buffering region, and determine whether a comparing result between the image data in the first buffering region and the image data in the second buffering region meets a predetermined difference condition.

In an exemplary embodiment, the outputting device can be configured to in response to determining that the comparing result between the image data in the first buffering region and the image data in the second buffering region meets the predetermined difference condition, output the image data in the first buffering region so as to refresh the display image of the display panel once and overwrite the image data in the first buffering region on the second buffering region.

In an exemplary embodiment, the frame skipping device can be configured to, in response to determining that the comparing result between the image data in the first buffering region and the image data in the second buffering region does not meet the predetermined difference condition, skip outputting of the image data in the first buffering region and wait to receive a next frame of image data from the processor.

In an exemplary embodiment, the predetermined difference condition can comprise any one or more of the following: a quantity of pixels which have changing brightness values between the image data in the first buffering region and the image data in the second buffering region is larger than a first parameter; there is a pixel region in which the sum of changes of brightness values between the image data in the first buffering region and the image data in the second buffering region is larger than a second parameter; and there are changing regions between the image data in the first buffering region and the image data in the second buffering region between which a center interval is larger than a third parameter.

In an exemplary embodiment, the determining device can be configured to, compare the frame of image data with at least two frames of image data so as to determine whether the frame of image data passes the dynamic image verification.

In a further aspect in accordance with the present disclosure, there is provide a timing controller. In an exemplary embodiment, the timing controller can comprise a receiving circuit configured to receive image data from a processor; a display interface circuit configured to output the image data; a picture analysis circuit configured to determine whether the image data received from the processor passes a dynamic image verification; and in response to determining that the image data passes the dynamic image verification, output the image data so as to refresh a display image of the display panel once; or in response to determining that the image data does not pass the dynamic image verification, skip outputting of the image data so as to skip refreshing of the display image of the display panel once.

In an exemplary embodiment, the timing controller can further comprise a first frame buffer configured to save a frame of image data most-recently received by the receiving circuit, and a second frame buffer configured to save a frame of image data most-recently output by the display interface circuit. The picture analysis circuit can be further configured to, whenever the image data in the first frame buffer is updated, compare the image data in the first frame buffer with the image data in the second frame buffer, and if a comparing result between the image data in the first frame buffer and the image data in the second frame buffer meets a predetermined difference condition, control the display interface circuit to output the image data in the first frame buffer and overwrite the image data in the first frame buffer on the second frame buffer, or if the comparing result between the image data in the first frame buffer and the image data in the second frame buffer does not meet the predetermined difference condition, skip outputting of the image data in the first frame buffer.

In an exemplary embodiment, the picture analysis circuit can be further configured to, if no image data is output within a first predetermined time length since the display interface circuit output any frame of image data, control the display interface circuit to output the image data in the first frame buffer and overwrites the image data in the first frame buffer on the second frame buffer.

In an exemplary embodiment, a reciprocal of the first determined time length in seconds can be less than a frame rate in which the processor transmits image data frame by frame.

In an exemplary embodiment, the predetermined difference condition can comprise any one or more of the following: a quantity of pixels which have changing brightness values between the image data in the first buffering region and the image data in the second buffering region is larger than a first parameter; there is a pixel region in which the sum of changes of brightness values between the image data in the first buffering region and the image data in the second buffering region is larger than a second parameter; and there are changing regions between the image data in the first buffering region and the image data in the second buffering region between which a center interval is larger than a third parameter.

In a still further aspect in accordance with the present disclosure, there is provided a display device. In an exemplary embodiment, the display device comprises the apparatus as described above or the timing controller as described above.

In a still further aspect in accordance with the present disclosure, there is provided a computer readable storage medium. In an exemplary embodiment, the computer readable storage medium stores computer executable instructions which, when executed by a processor, cause the processor to execute the method as described above.

### BRIEF DESCRIPTION OF THE DRAWINGS

The drawings needed in the description of embodiments will be simply introduced below so as to illustrate the technical solutions in the embodiments of the present disclosure more clearly. It is apparent that the drawings in the following description are only some embodiments of the present disclosure and all of reasonable variations of these drawings are included in the scope of the present disclosure.

FIG. 1 is a schematic structure diagram of a display device provided by an exemplary embodiment;

FIG. 2 is a schematic flowchart of a method for controlling a refresh rate of a display panel provided by an exemplary embodiment;

FIG. 3 is a schematic flowchart of a method for controlling a refresh rate of a display panel provided by another exemplary embodiment;

FIG. 4 is a schematic structure diagram of a timing controller provided by an exemplary embodiment;

FIG. 5 is a schematic structure diagram of a timing controller provided by another exemplary embodiment;

FIG. 6 is a schematic structure diagram of a timing controller provided by an example of the related art; and

FIG. 7 is a schematic structure diagram of an apparatus for controlling a refresh rate of a display panel provided by an exemplary embodiment.

### DETAILED DESCRIPTION

In order to make objects, technical solutions and advantages of the present disclosure more clear, exemplary embodiments of the present disclosure will be further described below in detail in combination with the drawings. The described embodiments are exemplary embodiments of the present disclosure, rather than all of the embodiments. All of other embodiments obtained by those of ordinary skill in the art based on the described exemplary embodiments of the present disclosure fall in the scope of the present disclosure. Unless otherwise defined, technical terms or scientific terms used in the present disclosure should have a common sense understood by those of ordinary skill person in the art of the present disclosure. Words “First”, “Second” and similar words used in the present disclosure do not represent any order, quantity or importance, but are only used for distinguishing different components. Word “comprising” or a similar word means that an element or an object prior to the word covers an element or an object listed after the word and equivalents thereof, and does not exclude other elements or objects. Words such as word “connecting” or “coupling” are not limited to physical or mechanical connections, but can include electrical connections and the connections can be direct or indirect.

Current products using PSR or PSR2 technology are still high in overall energy consumption and cannot meet the application requirement in the portable environment. The present disclosure provides a timing controller, a display device, a method and an apparatus for controlling a refresh rate. It can be known from the technical solutions of the present disclosure that, since every frame of image data can be or not be output based on whether it passes a dynamic image verification, the refresh rate of the display panel can present a dynamic change, i.e., the refresh rate of the panel can be consistent with the frame rate of the processor when the processor transmits a dynamic video stream, and the refresh rate of the panel can be reduced relatively when the processor transmits a static video stream. Compared with an implementation of PSR and PSR2 having a constant panel refresh rate, the present disclosure can reduce the power consumption of the panel refresh in displaying the static image while ensuring the dynamic displaying effect, thus contributing to reduce the overall power consumption of the product and extend the duration of the portable product.

FIG. 1 is a schematic structure diagram of a display device provided by an exemplary embodiment. With reference to FIG. 1, the display device can include a processor 100 (also referred as a picture controller), a timing controller 200, a source driver 300, a gate driver 400 and a display region circuit 500. Of course, the display device can also include structures other than those shown in FIG. 1. In an example of a display driving process, the processor 100 transmits a video stream to the timing controller 200 via a display interface based on the embedded displayport (eDP) standard. The transmitted video stream is frames of image data ordered based on the frame rate. The timing controller 200 receives the video stream from the processor 100 via the display interface, thus outputting every frame of image data in the video stream in order of the frame rate. In an example of a process of outputting image data by the timing controller, the timing controller 200 transmits to the source driver 300 a data signal generated based on the image data, and transmits synchronized timing controlling signals to the source driver 300 and the gate driver 400 respectively, so that the source driver 300 and the gate driver 400 collaboratively output driving signals to the display region circuit 500 so as to carry out frame-by-frame writing of a data voltage in each pixel, thus implementing refreshing of every frame of image of the display panel. It is understood that the display panel as a product can include only the display region circuit 500 of the above-described display device, and can further include any one or more of the processor, the timing controller, the source driver and the gate driver. For example, the display panel can include the display region circuit within a display region and the gate driver outside the display region, or the display panel can include the display region circuit within the display region, and the gate driver, the timing controller and the source driver outside the display region.

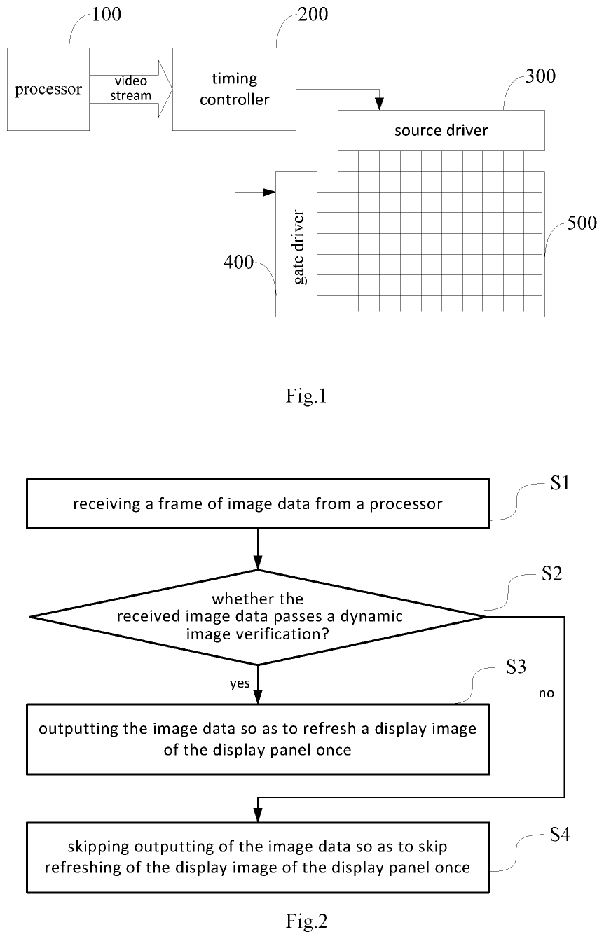

FIG. 2 is a schematic flowchart of a method for controlling a refresh rate of a display panel provided by an embodiment of the present disclosure. With reference to FIG. 2, the method can include a step S1 of receiving a frame of image data from a processor.

It is noted that the receiving herein can be for example a part of a process of receiving a video stream with a constant frame rate according to a matching port protocol, and can also be a part of a process of receiving a video stream with an inconstant frame rate according to a matching port protocol. The directly-received data can be for example an entire frame of image data, and can also be image data of an image region changed relative to the last frame of image data. The image data of the image region can be recovered to an entire frame of image data so as to complete the process of receiving. Also, there can be a sleep in the process of receiving image data from the processor. For example, a receiving component for receiving image data from the processor can be closed after receiving a sleep control signal, and can be recovered into an operating state after receiving a wakeup signal.

The method can also include a step S2 of determining whether the received image data passes a dynamic image verification.

Further, the method can also include a step S3 of, in respond to determining that the received image data passes the dynamic image verification, outputting the image data so as to refresh a display image of the display panel once.

The method can also include a step S4 of, in response to determining that the received image data does not pass the dynamic image verification, skipping outputting of the image data so as to skip refreshing of the display image of the display panel once. In an example, the skipping outputting of the image data can include directly ending the related operation of the received current frame of image data and beginning to wait for a next frame of image data from the processor.

It is understood that the steps S1, S2, S3 and S4 constitute a loop body. According to the present disclosure, a video stream (i.e. multiple frames of image data) with a constant or inconstant frame rate can be received from the processor according to the matching port protocol. Therefore, the multiple frames of image data can be received in sequence, so that the method shown in FIG. 2 can be carried out multiple times. Whenever a frame of image data is received from the processor (i.e. step S1 is carried out once), step S2 and step S3 or step S4 can be further carried out.

According to an exemplary embodiment, an order of display images of the display panel needs to be consistent with that of display images transmitted by the processor. Therefore, generally, multiple frames of image data in the video stream can be received, verified, and output in sequence. According to the present disclosure, a currently-received frame of image data can be directly verified when received, and can also be verified after buffered for a time period. In an embodiment, with respect to three successive frames of image data P1, P2 and P3, the image data P1 can be buffered when received, and then be verified to output or skip when receiving the image data P2; the image data P2 can be buffered when received, and then be verified to output or skip when receiving the image data P3; and so on. In another embodiment, with respect to three successive frames of image data P1, P2, P3 and P4, they can be sequentially buffered in batches, and then sequentially verified in batches. For example, P1 and P2 can be sequentially buffered when received, and then can be sequentially verified to output or skip when receiving P3 and P4.

It is noted that the dynamic image verification according to the present disclosure refers to a process in which whether skipping displaying of a frame of image in a series of images can have a remarkable impact on a dynamic displaying effect of the series of images is determined by comparing a difference between images for example. If it can result in a remarkable influence, it is referred that the frame of image passes the dynamic image verification relative to other images in the series of images, and vice versa. In an example, the dynamic image verification in the above-described step S2 can include, determining whether the currently-received frame of image data meets a predetermined difference condition (i.e. a predetermined condition for determining whether the difference is remarkable enough) relative to the received last frame of image data. If the difference condition is met, the currently-received frame of image data passes the dynamic image verification relative to the received last frame of image data. In another example, with respect to the three received successive frames of image data P1, P2 and P3, if any two of the three have a remarkable difference, the image data P2 passes the dynamic image verification relative to the image data P1 and the image data P3. It is understood that the form and the parameter of the dynamic image verification can be different according to different display quality requirements; moreover, at least one frame of image data (e.g. image data P1 and P3) as a comparison object should remain in a usable status in the process of the dynamic image verification.

It is also noted that the executive body of the method of the embodiment can be for example the timing controller or an apparatus or a circuit structure disposed between the timing controller and the two drivers (i.e. the source driver and the gate driver) for controlling the refresh rate of the display panel. In order to carry out each dynamic image verification, the timing controller or the apparatus or the circuit structure can include a storing component for storing image data, and update the stored data with updating of the required image data.

It can be seen that, if the processor transmits image data in a first frame rate, since the method according to the present disclosure outputs or skips every frame of image data according to the result of the dynamic image verification, the refresh rate of the display panel can be in a range below the first frame rate. With respect to a dynamic video stream in which every frame of image data passes the dynamic image verification, the refresh rate of the display image can be consistent with the first frame rate. With respect to a video stream which includes image data unable to pass the dynamic image verification, the refresh rate of the display image can be relatively reduced in a time period corresponding to the image data. As such, the refresh rate of the display panel can present a dynamic change which is adapted to the display requirement. That is to say, the dynamic displaying effect of the display panel can be ensured, and the refresh rate of the display panel can be relatively reduced to save power consumption at the same time. Therefore, the embodiments of the present disclosure are helpful to reduce the overall power consumption of the portable product and extend the duration of the portable product.

In an example, the method of the exemplary embodiment can also include a step between the steps S1 and S2 shown in FIG. 2 that is not shown in FIG. 2: determining whether image data is output within a first predetermined time length since image data was output last time. If yes, the method of the embodiment of the present disclosure can proceed to carry out the step S2; and if no, the method of the embodiment of the present disclosure can proceed to carry out the step S3. In an exemplary embodiment, a reciprocal of the first predetermined time length in seconds can be less than the frame rate when the processor transmits image data frame by frame. In the case of that successive frames of image data from the processor do not pass the dynamic image verification, continuous skipping of refreshing the display image (i.e. not refreshing the display image all the time) possibly makes the display status of the images unable to be kept. Therefore, the first predetermined time length can be set on the basis of the above-described steps S1 to S4 so as to ensure that the refresh rate of the display image cannot be less than the specified lowest limit. For example, on the basis of the first frame rate of 60 Hz, the reciprocal of the first predetermined time length in seconds can be set as the lowest frame rate of 1 Hz which can be supported by the display panel (i.e. the first predetermined time length is one second). Whenever a time length since image data was output last time reaches 1 second, the dynamic image verification is ignored and the most recently-received frame of image data is directly output so that the refresh rate of the display panel cannot be less than 1 Hz. In an embodiment, whenever a time length since image data was output last time reaches 1 second, the earliest buffered frame of image data in the buffered image data, rather than the most-recently received frame of image data, can be directly output. The output data can be set according to application requirements. For example, a value of the above-described first predetermined time length can be read from a hardware storage when powered on, and configuration of parameter items in related determining conditions can be implemented in sequence.

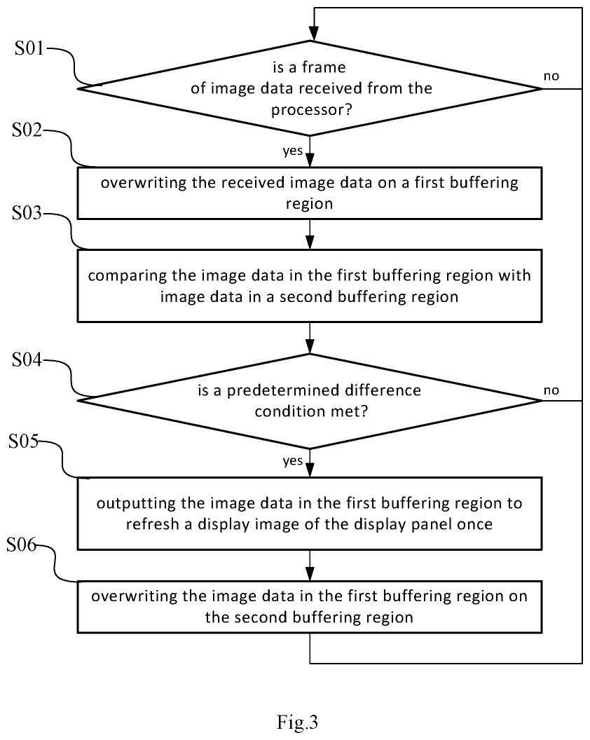

FIG. 3 is a schematic flowchart of a method for controlling a refresh rate of a display panel provided by another exemplary embodiment. With reference to FIG. 3, the method can include a step S01 of determining whether a frame of image data is received from a processor.

In response to determining that the frame of image data is received from the processor, the method can also include a step S02 of overwriting the received frame of image data on a first buffering region. In response to determining that the frame of image data is not received from the processor, the method carries out waiting and proceeds to implement the step S01.

After the step S02, the method can also include a step S03 of comparing the image data in the first buffering region with image data in a second buffering region. In an exemplary embodiment, the image data in the second buffering region is a most-recently output frame of image data. In an exemplary embodiment, the image data in the second buffering region is possibly null. In this case, the comparing result between the image data in the first buffering region and the image data in the second buffering region can be regarded as presence of a sufficiently remarkable difference.

After the step S03, the method can also include a step S04 of determining whether the comparing result between the image data in the first buffering region and the image data in the second buffering region meets a predetermined difference condition.

Next, in response to determining that the comparing result meets the predetermined difference condition, the method can also include a step S05 of outputting image data in the first buffering region to refresh the display image of the display panel once. In response to determining that the comparing result does not meet the predetermined difference condition, the outputting of the image data in the first buffering region is skipped to wait for a next frame of image data from the processor. Then, the method can return to the step S01.

After the step S05, the method can also include a step S06 of overwriting the image data in the first buffering region on the second buffering region.

It is understood that, the first buffering region of the exemplary embodiment is used for saving the most-recently received frame of image data and is continually updated with receiving of the image data. The second buffering region is used for saving the most-recently output frame of image data and is continually updated with outputting of the image data. Thus, the above-described method for controlling the refresh rate of the display panel can be implemented using least a storage space of two frames of image data. This is not only helpful to save the hardware cost and layout space, but also is helpful to save the time overhead and the power consumption overhead of data reading and writing.

On the basis of the process shown in FIG. 3, related configuration of the above-described first predetermined time length can be implemented in the exemplary embodiment. For example, the related configuration of the first predetermined time length can be implemented by setting a timer matching with the first predetermined time length. In particular, the method can further include in the step S05, resetting and starting a timer while outputting the image data. Based on this, the method can for example further include between the step S01 and the step S02, determining whether a time length of the timer reaches the first predetermined time length. In this case, in response to determining that the time length of the timer reaches the first predetermined time length, the method can proceed to the step S05, and in response to determining that the time length of the timer does not reach the first predetermined time length, the method can proceed to carry out the step S02.

It is noted that, if the predetermined difference condition is met and/or the time length of the timer reaches the first predetermined time length, the process of outputting the image data and the process of overwriting the image data in the first buffering region on the second buffering region can be exchanged in terms of execution order, and can also be implemented at the same time. In an example, the image data in the first buffering region can be firstly overwritten on the second buffering region, and then the image data in the second buffering region is output. The obtained execution result is the same as that of the above operations.

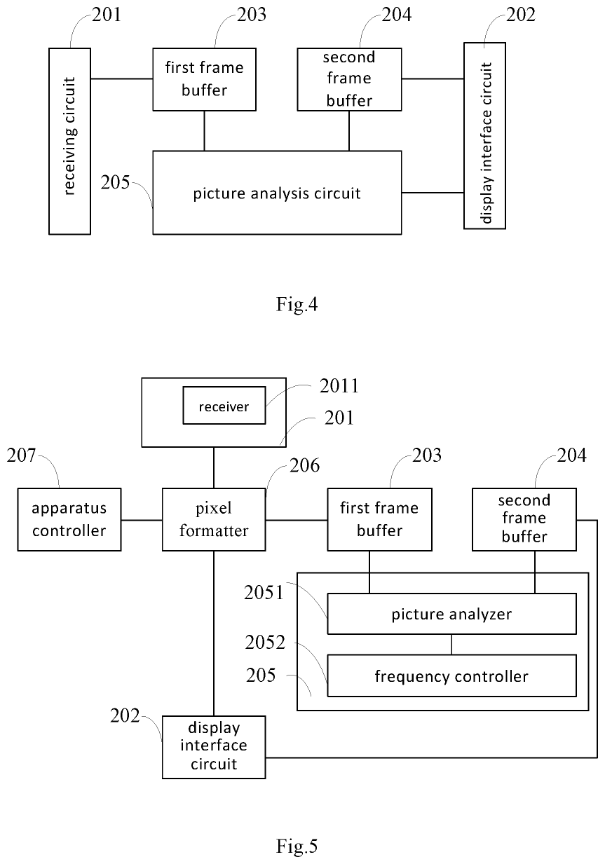

FIG. 4 is a schematic structure diagram of a timing controller provided by an exemplary embodiment. With reference to FIG. 4, the timing controller can include a receiving circuit 201, a display interface circuit 202 and a picture analysis circuit 205. In an embodiment, the timing controller can include only the three components. In this case, the receiving circuit 201 can be configured to receive image data from a processor. The display interface circuit 202 can be configured to output the image data. The picture analysis circuit 205 cam be configured to determine whether the image data received from the processor passes a dynamic image verification; and in response to determining that the image data passes the dynamic image verification, output the image data so as to refresh the display image of the display panel once; or in response to determining that the image data does not pass the dynamic image verification, skip outputting of the image data so as to skip refreshing of the display image of the display panel once.

In an exemplary embodiment, as shown in FIG. 4, in addition to the receiving circuit 201, the display interface circuit 202 and the picture analysis circuit 205, the timing controller can include a first frame buffer 203 and a second frame buffer 204. The first frame buffer 203 can be configured to save a frame of image data most-recently received by the receiving circuit 201. The second frame buffer 204 can be configured to save a frame of image data most-recently output by the display interface circuit 202. In this case, the picture analysis circuit 205 can be configured to, whenever the image data in the first frame buffer 203 is updated, compare the image data in the first frame buffer 203 with the image data in the second frame buffer 204. The picture analysis circuit 205 can also be configured to, if a comparing result between the image data in the first frame buffer 203 and the image data in the second frame buffer 204 meets a predetermined difference condition, control the display interface circuit 202 to output the image data in the first frame buffer 203 and overwrite the image data in the first frame buffer 203 on the second frame buffer 204, or if a comparing result between the image data in the first frame buffer 203 and the image data in the second frame buffer 204 does not meet the predetermined difference condition, skip outputting of the image data in the first frame buffer.

In an example, as shown in FIG. 4, the receiving circuit 201 connected with the first frame buffer 203 can be configured to, whenever a frame of image data is received from the processor, overwrite the frame of image data on the first frame buffer 203. The picture analysis circuit 205 connected with the first frame buffer 203 can be configured to, whenever the image data in the first frame buffer 203 is updated, compare image data in the two frame buffers, and if a difference between each other meets the predetermined difference condition, overwrite the image data in the first frame buffer 203 on the second frame buffer 204 and then control the display interface circuit 202 to output the image data in the second frame buffer 204 (at this time, that is the image data in the first frame buffer 203). In an example, if the predetermined difference condition is met, the picture analysis circuit 205 transmits a control signal to the connected display interface circuit 202, so that the display interface circuit 202 which receives the control signal reads image data from the connected second frame buffer 204 and outputs it.

It can be seen that, the above-described working process of the timing controller shown in FIG. 4 is an example of the method as shown in FIG. 2 or 3: the receiving and outputting of the image data are implemented by the receiving circuit 201 and display interface circuit 202 respectively; the first buffering region and the second buffering region are provided by the first frame buffer 203 and the second frame buffer 204 respectively; and the comparing, outputting and controlling of the image data are implemented by the picture analysis circuit 205. As a whole, the timing controller can dynamically control the refresh rate of the display panel and reduce the total power consumption on the basis of the video stream transmitted by the processor.

Also, the picture analysis circuit 205 can be configured to, if no image data is output within a first predetermined time length since the display interface circuit 202 output anyone frame of image data, when the first predetermined time length expires, control the display interface circuit 202 to output the image data in the first frame buffer 203 and overwrite the image data in the first frame buffer 203 on the second frame buffer 204. Thus, it is ensured that the refresh rate of the display image cannot be less than the specified lowest limit.

In a variated example, the display interface circuit 202 is connected only with the first frame buffer 203 and is not connected with the second frame buffer 204, so that when implementing outputting of the image data, the picture analysis circuit 205 can firstly output the image data in the first frame buffer 203 and then overwrite the image data in the first frame buffer 203 on the second frame buffer 204. Also, the display interface circuit 202 can also be connected with both of the first frame buffer 203 and the second frame buffer 204 so that image data in both of the two frame buffers can be directly output.

In a variated example, the picture analysis circuit 205 can also be connected with the receiving circuit 201 so that when receiving regional image data from the processor, the receiving circuit 201 recovers it in the first frame buffer 203 into an entire frame of image data.

In an example, the picture analysis circuit 205 of the exemplary embodiment can for example include a hardware logical circuit implemented by a gate circuit. In another example, the picture analysis circuit 205 of the exemplary embodiment can for example include a readable storage medium storing instructions and a controller able to execute the instructions. Functions implemented by the picture analysis circuit 205 can be implemented by means of a pure hardware circuit, or completely by means of a process of executing instructions by a controller, or combination thereof. Implementation of the functions of the picture analysis circuit 205 can be set depending on application requirements.

Also, on the basis of anyone of the above-described implementations, more than two buffering regions or frame buffers can be set to save more than two frames of image data at the same time. For example, in the case of the above-described application scene in which the image data P1 and P3 are needed to implement the dynamic image verification to image data P2, three frame buffers can provide three different buffering regions respectively and are used to save a most-recently received frame of image data, a frame of image data received immediately before the most-recently received frame of image data, a most-recently output frame of image data respectively. Base on this, the processes of comparing and overwriting as shown in FIG. 3 can be adjusted adaptively. This can also reduce the power consumption of the panel refreshing. In an example, when receiving the image data P3 from the processor, the received last frame of image data P2 saved in the first buffering region can be overwritten on the second buffering region and the image data P3 can be overwritten on the first buffering region. At this time, the most-recently output frame of image data P1 is in the third buffering region. Thus, comparing of image data P1 and P2 and comparing of image data P2 and P3 can be implemented respectively, and if the comparing result between the image data P1 and P2 meets a first predetermined difference condition and the comparing result between the image data P2 and P3 meets a second predetermined difference condition, it is determined that the dynamic image verification is passed, thus outputting the image data P2 in the second buffering region and overwriting the image data P2 on the third buffering region at the same time. If the dynamic image verification is not passed, the current process is directly ended and a next frame of image data from the processor is waited for. If no image data is output within the first predetermined time length since the display interface circuit output any one frame of image data, the image data in the second buffering region is directly output and overwritten on the third buffering region at the same time.

FIG. 5 is a schematic structure diagram of a timing controller provided by another embodiment of the present disclosure. With reference to FIG. 5, compared with the timing controller as shown in FIG. 4, the timing controller of the embodiment additionally includes a pixel formatter 206 and an apparatus controller 207.

As shown in FIG. 5, the receiving circuit 201 can include an eDP receiver 2011 using the embedded displayport (eDP) standard. The receiver 2011 is connected with the first frame buffer 203 via the pixel formatter 206 so as to convert the data from the processor into a frame of image data in the first frame buffer 203 through the pixel formatter 206 when the receiver 2011 is in the operating state.

As shown in FIG. 5, the picture analysis circuit 205 can include a picture analyzer 2051 and a frequency controller 2052. The frequency controller 2052 can be configured to generate and output a control signal for controlling the refresh rate of the display panel. The picture analyzer 2051 can be configured to process the image data (e.g. comparing and saving the image data) and control the frequency controller. In an example, the frequency controller 2052 can include a timer circuit not shown in FIG. 5. Whenever the frequency controller 2052 controls the display interface circuit 202 to output the image data through the control signal, the frequency controller 2052 resets and starts the timer circuit, and if a time length of the timer circuit reaches the first predetermined time length, the frequency controller 2052 outputs the image data in the first frame buffer 203, and at the same time, the picture analyzer 2051 overwrites the image data in the first frame buffer 203 on the second frame buffer 204.

The pixel formatter 206 is configured to convert the data from the processor into image data, and also configured to convert the image data into a format adapted to the display interface circuit 202. In an example, the pixel formatter 206 can include a controller and a storage. The controller can execute instructions stored in the storage, and the instructions can for example include a program for implementing the above-described converting process. The apparatus controller 207 can be configured to, when powered on, obtain, from the external storage, parameters such as the above-described first predetermined time length and the highest frame rate supported by the display panel, and implement configuration of the parameters through the pixel formatter 206.

In an example, both of the processor and the timing controller can operate in multiple operating modes such as a general display mode, an entering panel self-refresh mode, a panel self-refresh mode entering regional image refresh, an ending panel self-refresh mode, and so on.

In the general display mode, the processor transmits image data to the timing controller in a regular frame rate such as 60 Hz. At this time, the receiver 2011 in the timing controller and the pixel formatter 206 can remain in the operating state, and the first frame buffer 203, the second frame buffer 204, the picture analyzer 2051 and the frequency controller 2052 can remain in the closed state, so that the timing controller refreshes the display panel directly based on the transmitting frame rate of the processor. At this time, the refresh rate of the panel is 60 Hz.

In the entering panel self-refresh mode, the processor detects that the currently displayed video stream is a static video stream, and the processor thus transmits the last frame of image data to the timing controller and at the same time controls the timing controller to enter the self-refresh mode. Hereafter, after the last frame of image data is overwritten on the first frame buffer 203, the receiver 2011 closes and turns off a main link with the processor, and at the same time, the first frame buffer 203, the second frame buffer 204, the picture analyzer 2051 and the frequency controller 2052 are turned on. The picture analyzer 2051 overwrites the image data in the first frame buffer 203 on the second frame buffer 204. The frequency controller 2052 controls the display interface circuit 202 based on the preconfigured first predetermined time length to output the above-described last frame of image data in the lowest frame rate supported by the display panel. For example, the display panel can be repeatedly refreshed with a same static image in a frame rate of 1 Hz under the control of the frequency controller 2052. In this process, the operation of overwriting the image data in the first frame buffer 203 on the second frame buffer 204 cannot be implemented in each process of outputting the image data.

In the panel self-refresh mode entering regional image refresh, when the processor detects that the video stream to be displayed only has a local image change, the processor transmits a control signal to the timing controller so as to wake up the receiver 2011 and restart the main link. After ending the sleep, the receiver 2011 begins to receive the regional image data form the processor in a frame rate of e.g. 40 Hz, and update the image data in the first frame buffer 203 in a frequency of 40 Hz through the pixel formatter 206. Within a time length less than 1/40 second, the picture processor 2051 completes processing of the current frame (the most-recently received frame) of image data: implementing the dynamic image verification to the current frame of image data by comparing the image data in the first frame buffer 203 and the second frame buffer 204; if the dynamic image verification is passed, the picture processor 2051 outputting the current frame of image data through the pixel formatter 206 and at the same time overwriting the image data in the first frame buffer 203 on the second frame buffer 204; and if the dynamic image verification is not passed, the picture processor 2051 ending processing of the current frame of image data. Whenever a time in which no image data is output reaches the first predetermined time length, the frequency controller 2052 outputs the image data in the first frame buffer 203 and overwrites the image data in the first frame buffer 203 on the second frame buffer 204. Thus, the refresh rate of the display panel can be dynamically changed in a range between 1 Hz and 40 Hz.

In an example, with respect to the above-described dynamic image verification, determining whether the comparing result between the image data in the first frame buffer 203 and the image data in the second frame buffer 204 meets the predetermined difference condition can include, if anyone of sub-conditions of the predetermined difference condition is met, the dynamic image verification is passed. As an example, the sub-conditions of the predetermined difference condition can include any one or more of the following:
a quantity of pixels which have changing brightness values between two frames of image data is larger than a first parameter;
there is a 4×4 pixel region in which the sum of changes of brightness values between two frames of image data is larger than a second parameter; and
there are changing regions between two frames of image data between which the center interval is larger than a third parameter, the changing region is a rectangle pixel region in which each side includes at least one pixel having a changing brightness value, and a quantity of pixels in each side is no less than 3.

In an example, the first parameter, the second parameter and the third parameter can be read from the hardware storage together with the first predetermined time length when the timing controller is powered on, and corresponding configuration is implemented based on this so as to be used when performing the dynamic image verification.

It can be seen that, for example, by meeting anyone of the above-described sub-conditions, it is determined that skipping of displaying the current frame has a remarkable impact on the dynamic displaying effect, thus determining that the dynamic display verification is passed. Of course, according to the above-described example, other forms of dynamic image verification processes can be determined depending on application requirements. For example, one or more factors among a quantity of pixels having changing brightness values, a change of an average brightness value in each unit area, a center interval between changing regions, and a quantity, an area and a sum of changes in brightness value, of changing regions can be used for setting the difference condition, and are not limited only to this.

In the ending panel self-refresh mode, when the processor transmits a control signal to the timing controller so as to make it exit the panel self-refresh mode, the receiver 2011 and the pixel formatter 206 are changed into the operating state. The first frame buffer 203, the second frame buffer 204, the picture analyzer 2051 and the frequency controller 2052 are turned into the closed state and begin to operate in the general display mode for example.

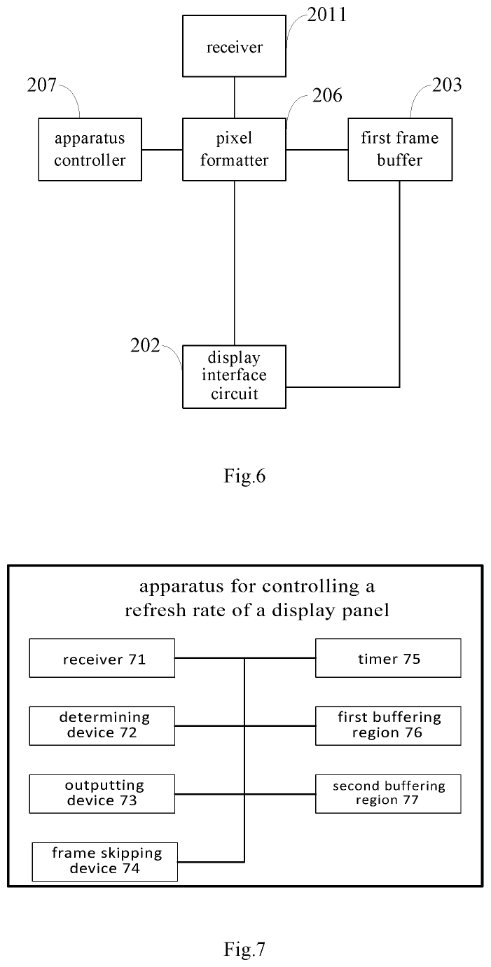

FIG. 6 is a schematic structure diagram of a timing controller provided by an example of the related art. With reference to FIG. 6, compared with the timing controller as shown in FIG. 5, the timing controller of the embodiment omits the second frame buffer 204, the picture analyzer 2051 and the frequency controller 2052, and outputs image data directly through the pixel formatter 206. In the above-described panel self-refresh mode, the pixel formatter 206 controls the display interface circuit 202 to output the image data in the first frame buffer 203 in a constant frame rate (e.g. 60 Hz). In the above-described panel self-refresh mode having a reginal image refresh, the receiver 2011 updates the image data in the first frame buffer 203 in a constant frame rate (e.g. 60 Hz), and the pixel formatter 206 still controls the display interface circuit 202 to output the image data in the first frame buffer 203 in a constant frame rate (e.g. 60 Hz). Thus, the refresh rate of the display panel can remain in 60 Hz all the time.

By analyzing the structure as shown in FIG. 6, it can be known that, if the above-described constant frame rate of outputting the image data is reduced (e.g. being reduced to 10 Hz), the refresh rate of the display panel can remain in 10 Hz in the panel self-refresh mode and the panel self-refresh mode having the regional image refresh. In this case, the displaying effect of the dynamic video stream can be impacted severely, thus resulting in a display problem such as a smear. For example, if a mouse is suddenly moved after the mouse is stopped for a time period, a severe mouse smear will occur. Therefore, in order to ensure the displaying effect of the dynamic video stream, the structure as shown in FIG. 6 can generally set the refresh rate of the display panel as a larger value.

However, with respect to the timing controller of the exemplary embodiments, since the displaying effect of the dynamic video stream can be ensured by outputting image data based on the dynamic image verification, the refresh rate of the display panel can be set as the allowable lowest value in the panel self-refresh mode and the panel self-refresh mode having the regional image refresh so as to highly reduce the power consumption resulting from refreshing the display image of the display panel in high frequency.

Based on the same inventive concept, FIG. 7 shows a schematic structure diagram of an apparatus for controlling a refresh rate of a display panel provided by a further exemplary embodiment. With reference to FIG. 7, the apparatus can include a receiver 71, a determining device 72, an outputting device 73, a frame skipping device 74, a timer 75, a first buffering region 76 and a second buffering region 77.

The receiver 71 can be configured to receive a frame of image data from a processor. In an exemplary embodiment, the receiver 71 can continually receive multiple frames of image data from the processor. The determining device 72 can be configured to determine whether the received frame of image data passes a dynamic image verification. The outputting device 73 can be configured to, in response to determining that the frame of image data passes the dynamic image verification, output the frame of image data so as to refresh the display image of the display panel once. The frame skipping device 74 can be configured to, in response to determining that the frame of image data does not pass the dynamic image verification, skip outputting of the frame of image data so as to skip refreshing of the display image of the display panel once.

The timer 75 can be configured to be started or restarted when outputting the frame of image data, and to be matched with a first predetermined time length. In an exemplary embodiment, the reciprocal of the first predetermined time length in seconds can be less than a frame rate in which the processor transmits image data frame by frame. The reciprocal of the first predetermined time length in seconds can be the lowest frame rate supported by the display panel. If the timer 75 is started, the determining device 72 can be configured to determine whether image data is output within the first predetermined time length since the frame of image data was output, and the outputting device 73 can be configured to, in response to determining that no image data is output within the first predetermined time length since the frame of image data was output, output a current frame of image data received from the processor in real time. In an embodiment, when the receiver 71 receives a frame of image data from the processor, the determining device 72 can determine whether the timer 75 experiences the first predetermined time length. If it is determined that the timer 75 experiences the first predetermined time length, the frame of image data is directly output without further determining whether the frame of image data passes the dynamic image verification.

The first buffering region 76 can be configured to overwrite a frame of image data when receiving the frame of image data from the processor. The second buffering region 77 can be configured to save the most-recently output frame of image data. In this case, the determining device 72 can be configured to, compare the image data in the first buffering region and the image data in the second buffering region, and determine whether a comparing result between the image data in the first buffering region and the image data in the second buffering region meets a predetermined difference condition. The outputting device 73 can be configured to, in response to determining that the comparing result between the image data in the first buffering region and the image data in the second buffering region meets the predetermined difference condition, output the image data in the first buffering region so as to refresh the display image of the display panel once and overwrite the image data in the first buffering region on the second buffering region. At this time, the timer 75 can be configured to be started or restarted when outputting the frame of image data and to be matched with the first predetermined time length. The frame skipping device 74 can be configured to, in response to determining that the comparing result between the image data in the first buffering region and the image data in the second buffering region does not meet the predetermined difference condition, skip outputting of the image data in the first buffering region and wait to receive a next frame of image data from the processor.

According to the present disclosure, as described above, the predetermined difference condition can include any one or more of the following:
a quantity of pixels which have changing brightness values between the image data in the first buffering region and the image data in the second buffering region is larger than a first parameter; and/or
there is a pixel region in which the sum of changes of brightness values between the image data in the first buffering region and the image data in the second buffering region is larger than a second parameter; and there are changing regions between the image data in the first buffering region and the image data in the second buffering region between which a center interval is larger than a third parameter.

In an exemplary embodiment, the determining device 72 can also be configured to, compare the frame of image data with at least two frames of image data so as to determine whether the frame of image data passes the dynamic image verification.

It is understood that the apparatus of the embodiment is corresponding to the above method for controlling the refresh rate of the display panel. Therefore, the specific examples of the embodiment can make reference to the above illustration and are not described repeatedly herein.

It can be seen that, since every frame of image data can be or not be output based on whether it passes the dynamic image verification, the refresh rate of the display panel can present a dynamic change, i.e., the refresh rate of the panel can be consistent with the frame rate of the processor when the processor transmits a dynamic video stream and the refresh rate of the panel can be reduced relatively when the processor transmits a static video stream. Compared with an implementation of PSR and PSR2 having a constant panel refresh rate, the embodiment of the present disclosure can reduce the power consumption of the panel refresh in displaying the static image while ensuring the dynamic displaying effect, thus contributing to reduce the overall power consumption of the product and extend the duration of the portable product.

In the exemplary embodiments corresponding to FIG. 7, the apparatus for controlling the refresh rate of the display panel is shown in the form of functional units/function modules. “Unit/module” herein can refer to an Application Specific Integrated Circuit (ASIC), a storage and a processor executing one or more software or firmware programs, an integrated logic circuit, and/or other devices that can provide the above-described functions. In an embodiment, the apparatus for controlling the refresh rate of the display panel can be implemented in a computer software.

An exemplary embodiment of the application also provides a computer readable storage medium which stores computer software instructions used by the apparatus for controlling the refresh rate of the display panel as shown in FIG. 7. When executed by the processor, the computer executable instructions cause the processor to be able to execute the method for controlling the refresh rate of the display panel provided by the application.

Based on the same inventive concept, an exemplary embodiment also provides a display device comprising any one of the above described timing controllers or any one of the above-described apparatuses for controlling the refresh rate of the display panel. The display device can be any product or component such as a display panel, a phone, a tablet computer, a TV, a display apparatus, a notebook computer, a digital photo frame, a navigator, and so on that has a display function. Based on the beneficial effect able to be obtained from the included structure, the display device can obtain the same or corresponding beneficial effect.

It is noted that, the controller as described herein can be for example an Application Specific Integrated circuit (ASIC), a digital signal processor (DSP), a digital signal processing device (DSPD), a programmable logic device (PLD), a field programmable gate array (FPGA), a central processing unit (CPU), a controller, a micro-controller, a micro-processor, and is not limited to this.

The above are only exemplary embodiments of the present disclosure and are not used for limiting the present disclosure. Any modification, equivalent replacement and improvement, etc. made within the spirit and principle of the present disclosure fall in the scope of the present disclosure.

1. A method for controlling a refresh rate of a display panel, the method comprising,
receiving a frame of image data from a processor;
determining whether the frame of image data passes a dynamic image verification; and
in response to determining that the frame of image data passes the dynamic image verification, outputting the frame of image data so as to refresh a display image of the display panel once; or
in response to determining that the frame of image data does not pass the dynamic image verification, skipping outputting of the image data so as to skip refreshing of the display image of the display panel once.

2. The method according to claim 1, further comprising,
starting a timer matching with a first predetermined time length while outputting the frame of image data;
determining that whether image data is output within the first predetermined time length since the frame of image data was output; and
in response to determining that no image data is output within the first predetermined time length since the frame of image data was output, outputting a current frame of image data received from the processor in real time.

3. The method according to claim 2, wherein a reciprocal of the first determined time length in seconds is less than a frame rate in which the processor transmits image data frame by frame.

4. The method according to claim 1, wherein the method further comprises overwriting a frame of image data on a first buffering region when receiving the frame of image data from the processor, and wherein the determining whether the frame of image data passes a dynamic image verification comprises,
comparing the image data in the first buffering region and image data in a second buffering region, wherein the image data in the second buffering region is a most-recently output frame of image data; and
determining whether a comparing result between the image data in the first buffering region and the image data in the second buffering region meets a predetermined difference condition.

5. The method according to claim 4, wherein, in response to determining that the frame of image data passes the dynamic image verification, outputting the frame of image data so as to refresh the display image of the display panel once comprises,
in response to determining that the comparing result between the image data in the first buffering region and the image data in the second buffering region meets the predetermined difference condition, outputting the image data in the first buffering region so as to refresh the display image of the display panel once and overwriting the image data in the first buffering region on the second buffering region.

6. The method according to claim 4, wherein in response to determining that the frame of image data does not pass the dynamic image verification, skipping outputting of the frame of image data so as to skip refreshing of the display image of the display panel once comprises,
in response to determining that the comparing result between the image data in the first buffering region and the image data in the second buffering region does not meet the predetermined difference condition, skipping outputting of the image data in the first buffering region and waiting to receive a next frame of image data from the processor.

7. The method according to claim 4, wherein the predetermined difference condition comprises any one or more of the following:
a quantity of pixels which have changing brightness values between the image data in the first buffering region and the image data in the second buffering region is larger than a first parameter;
there is a pixel region in which the sum of changes of brightness values between the image data in the first buffering region and the image data in the second buffering region is larger than a second parameter; and
there are changing regions between the image data in the first buffering region and the image data in the second buffering region between which a center interval is larger than a third parameter.

8. The method according to claim 1, wherein the determining whether the frame of image data passes a dynamic image verification comprises,
comparing the frame of image data with at least two frames of image data so as to determine whether the frame of image data passes the dynamic image verification.

9. An apparatus for controlling a refresh rate of a display panel, the apparatus comprising,
a receiver configured to receive a frame of image data from a processor;
a determining device configured to determine whether the frame of image data passes a dynamic image verification;
an outputting device configured to, in response to determining that the frame of image data passes the dynamic image verification, output the frame of image data so as to refresh a display image of the display panel once; and
a frame skipping device configured to, in response to determining that the frame of image data does not pass the dynamic image verification, skip outputting of the image data so as to skip refreshing of the display image of the display panel once.

10. The apparatus according to claim 9, wherein the apparatus further comprises a timer configured to be started while outputting the frame of image data and to be matched with a first predetermined time length, and wherein the determining device is configured to determine whether image data is output within the first predetermined time length since the frame of image data was output, and the outputting device is configured to, in response to determining that no image data is output within the first predetermined time length since the frame of image data was output, output a current frame of image data received from the processor in real time.

11. (canceled)

12. The apparatus according to claim 9, wherein the apparatus further comprises
a first buffering region configured to overwrite a frame of image data when receiving the frame of image data from the processor, and
a second buffering region configured to save a most-recently output frame of image data; and
wherein the determining device is configured to,
compare the image data in the first buffering region and the image data in the second buffering region, and
determine whether a comparing result between the image data in the first buffering region and the image data in the second buffering region meets a predetermined difference condition.

13. The apparatus according to claim 12, wherein the outputting device is configured to,
in response to determining that the comparing result between the image data in the first buffering region and the image data in the second buffering region meets the predetermined difference condition, output the image data in the first buffering region so as to refresh the display image of the display panel once and overwrite the image data in the first buffering region on the second buffering region.

14. The apparatus according to claim 12, wherein the frame skipping device is configured to,
in response to determining that the comparing result between the image data in the first buffering region and the image data in the second buffering region does not meet the predetermined difference condition, skip outputting of the image data in the first buffering region and wait to receive a next frame of image data from the processor.

15. The apparatus according to claim 12, wherein the predetermined difference condition comprises any one or more of the following:
a quantity of pixels which have changing brightness values between the image data in the first buffering region and the image data in the second buffering region is larger than a first parameter;
there is a pixel region in which the sum of changes of brightness values between the image data in the first buffering region and the image data in the second buffering region is larger than a second parameter; and
there are changing regions between the image data in the first buffering region and the image data in the second buffering region between which a center interval is larger than a third parameter.

16. The apparatus according to claim 9, wherein the determining device is configured to,
compare the frame of image data with at least two frames of image data so as to determine whether the frame of image data passes the dynamic image verification.

17. A timing controller comprising
a receiving circuit configured to receive image data from a processor;
a display interface circuit configured to output the image data;
a picture analysis circuit configured to determine whether the image data received from the processor passes a dynamic image verification; and in response to determining that the image data passes the dynamic image verification, output the image data so as to refresh a display image of the display panel once; or in response to determining that the image data does not pass the dynamic image verification, skip outputting of the image data so as to skip refreshing of the display image of the display panel once.

18. The timing controller according to claim 17, wherein the timing controller further comprises
a first frame buffer configured to save a frame of image data most-recently received by the receiving circuit, and
a second frame buffer configured to save a frame of image data most-recently output by the display interface circuit; and
wherein the picture analysis circuit is further configured to,
whenever the image data in the first frame buffer is updated, compare the image data in the first frame buffer with the image data in the second frame buffer, and
if a comparing result between the image data in the first frame buffer and the image data in the second frame buffer meets a predetermined difference condition, control the display interface circuit to output the image data in the first frame buffer and overwrite the image data in the first frame buffer on the second frame buffer, or
if the comparing result between the image data in the first frame buffer and the image data in the second frame buffer does not meet the predetermined difference condition, skip outputting of the image data in the first frame buffer.

19. The timing controller according to claim 18, wherein the picture analysis circuit is further configured to,
if no image data is output within a first predetermined time length since the display interface circuit output any frame of image data, control the display interface circuit to output the image data in the first frame buffer and overwrites the image data in the first frame buffer on the second frame buffer.

20. (canceled)

21. (canceled)

22. A display device comprising the apparatus of claim 9.

23. A computer readable storage medium storing computer executable instructions which, when executed by a processor, cause the processor to execute the method of claim 1.
